(19) United States
(12) Patent Application Publication
(10) Pub. No.: US 2017/0130914 A1
(43) Pub. Date: May 11, 2017

(54) APPARATUS AND SYSTEM FOR A MULTI-MODAL FLASHLIGHT

(71) Applicant: LED Lenser Corp. Ltd., Yangjiang City (CN)

(72) Inventor: Falko Gassauer, Yangjiang City (CN)

(21) Appl. No.: 15/332,350

(22) Filed: Oct. 24, 2016

(30) Foreign Application Priority Data
Nov. 6, 2015 (CN) 201510757245.3

(51) Int. Cl. F21L 4/08; F21V 31/03; F21V 23/02; F21V 29/89; F21V 23/06; F21V 23/04; F21V 14/06; F21V 31/00; F21V 23/00

(52) U.S. Cl. CPC F21L 4/085; F21V 31/005; F21V 31/03; F21V 23/023; F21V 23/009; F21V 23/06; F21V 23/0428; F21V 23/0407; F21V 14/065; F21V 29/89; F21Y 2115/10

(57) ABSTRACT

Provided herein is a structure for supporting a light source. The structure may include a housing having a first longitudinal end and a second longitudinal end, with a cavity defined within the housing extending along a portion of a longitudinal length of the housing from the first longitudinal end. The structure may include a surface extending across the second longitudinal end, where the surface includes a light source receiving area, and an opening defined from the light source receiving area through the surface and opening to the cavity. A light source driving circuit may be received within the cavity and including at least one electrical connection extending from the light source driving circuit, through the opening to the light source receiving area. The light source receiving structure may be received within the flashlight. The housing may be cylindrical and may include a threaded exterior surface at the first longitudinal end.

### CROSS-REFERENCE TO RELATED APPLICATIONS

This application claims priority to Chinese Patent Application Serial No. 2015-10757245.3, filed on Nov. 6, 2015, the contents of which are herein incorporated by reference in their entirety.

### FIELD

Embodiments of the present invention generally relate to systems and methods for providing illumination and, more particularly, to an apparatus and system for a multi-modal flashlight.

### BACKGROUND

Electric light sources exist in a variety of form factors from residential or commercial light fixtures to hand-held flashlights. Conventional incandescent light bulbs have given way to more efficient fluorescent light bulbs and compact florescent light (CFL) bulbs to provide substantially similar light while consuming less power. While a florescent light is more efficient than an equivalently bright incandescent light, light-emitting diodes (LEDs) are more efficient still at producing an equivalent or brighter light in a particularly compact form factor.

LEDs were initially relatively expensive as compared to incandescent or florescent lights, and were not suitable for many applications. Additionally, low intensity and limited color options for LEDs limited their usefulness. Recent developments in the field of LEDs have caused LED light sources to become ubiquitous replacements or supplements to conventional light sources. Further, LEDs may be packaged in considerably smaller form factors than equivalently bright incandescent lights or florescent lights. LEDs may now be found in flashlights and other portable light sources which benefit from their compact size and energy efficiency.

As LEDs function in a manner different than that of florescent lights or incandescent lights, LEDs may offer functionality and utility previously not available in compact form factors, such as flashlights. Therefore, it may be desirable to exploit the capabilities of LEDs in compact form factors.

### SUMMARY

In light of the foregoing background, example embodiments of the present invention provide a flashlight. The flashlight of example embodiments may include a structure for supporting a light source. The structure may include a housing having a first longitudinal end and a second longitudinal end, with a cavity defined within the housing extending along a portion of a longitudinal length of the housing from the first longitudinal end. The structure may include a surface extending across the second longitudinal end, where the surface includes a light source receiving area, and an opening defined from the light source receiving area through the surface and opening to the cavity. A light source driving circuit may be received within the cavity and include at least one electrical connection extending from the light source driving circuit, through the opening to the light source receiving area. The light source receiving structure may be received within the flashlight. The housing may be cylindrical and may include a threaded exterior surface at the first longitudinal end. The light source driving circuit may include an electrical connector extending from the cavity of the cylindrical housing from the first longitudinal end of the cylindrical housing. The structure for supporting a light source may include a selector ring disposed about an exterior of the cylindrical housing, where the selector ring includes a magnet, and where the light source driving circuit includes at least one sensor for detecting a position of the magnet of the selector ring. The structure may optionally include a light source bracket attached to the surface and configured to secure a light source to the light source receiving area.

According to some embodiments described herein, a flashlight may be provided including a flashlight head having a light source housing, a light source supporting structure disposed at least partially within the light source housing, and a lens carrier received within the light source housing. At least one of the light source housing and the light source supporting structure may include a threaded end. The lens carrier may be translatable within the light source housing between a first distance relative to the light source supporting structure and a second distance relative to the light source supporting structure. A flashlight body may be configured to engage the threaded end of the flashlight head. The lens carrier may be translatable relative to the light source supporting structure in response to the light source housing being rotated relative to the light source supporting structure. The flashlight body may include a collar having a threaded inner surface, where the threaded surface of the collar may be configured to engage the threaded end of the flashlight head.

According to some embodiments, the light source supporting structure may include an electrical connector, where the flashlight body includes an electrical connector, where in response to the threaded collar of the flashlight body engaging the threaded end of the light source housing or the light source supporting structure, the electrical connector of the flashlight body engages the electrical connector of the light source supporting structure. The electrical connector of the light source supporting structure and the electrical connector of the flashlight body may include a keyed interface, where the electrical connectors are engagable with one another in a single rotational position there between based on the keyed interface. The threaded collar of the flashlight body may be rotatable relative to the power source, and the power source may be secured to the flashlight head in response to the threaded collar engaging the threads of the light source housing or the light source supporting structure and being rotated relative to the flashlight head and the flashlight body, while the flashlight body and the flashlight head remain in alignment.

Embodiments may include at least one pin extending from the light source supporting structure, where the lens carrier defines at least one aperture configured to receive therein the pin extending from the light source supporting structure, where the lens carrier is translatable along at least a portion of the length of the pin. A primary lens may be received at a first end of the flashlight head, opposite the threaded end, where the lens carrier is disposed within a closed cavity defined by the light source housing, the light sources supporting structure, and the primary lens. A seal may be disposed about the perimeter of the primary lens, and a second seal may be disposed between the light source supporting structure and the light source housing, where the first seal and the second seal cooperate to render the cavity impervious to water when the flashlight is submerged at a depth of at least twelve inches. The flashlight body may define a cavity therein including at least one power source, where the cavity of the power source is impervious to water at a depth of at least twelve inches. The cavity may be impervious to water when the flashlight is submerged in water at a depth of at least one hundred feet.

Embodiments described herein may provide a light emitting device having a light source housing, a light source supporting structure disposed at a first end of the light source housing, a primary lens disposed at a second, opposite end of the light source housing, and a lens carrier disposed between the light source supporting structure and the primary lens. The lens carrier may be adjustable along a length defined between the light source supporting structure and the primary lens. The light source supporting structure may include a plurality of light sources, and the lens carrier may include a plurality of lenses, with each lens corresponding to a respective light source. The light source supporting structure may include at least one pin extending therefrom, where the lens carrier includes at least one passage corresponding to the at least one pin. The lens carrier may be configured to translate along at least a portion of the length of the at least one pin. One of the light source housing and the lens carrier may include at least one focusing pin, where the other of the light source housing and the lens carrier includes at least one channel corresponding to the at least one focusing pin. In response to the light source housing being rotated relative to the light source supporting structure, the at least one focusing pin may translate along the at least one channel to move the lens carrier along the portion of the length of the at least one pin.

### BRIEF DESCRIPTION OF THE DRAWINGS

Having thus described the invention in general terms, reference will now be made to the accompanying drawings, which are not necessarily drawn to scale, and wherein:

FIG. 1 depicts a flashlight according to an example embodiment of the present invention;

FIG. 2 illustrates a perspective view of a flashlight body according to an example embodiment of the present invention;

FIG. 3 illustrates a perspective view of a flashlight head according to an example embodiment of the present invention;

FIG. 4 depicts a perspective view of a light source supporting structure according to an example embodiment of the present invention;

FIG. 5 illustrates a cut-away view of a flashlight head as separated from a flashlight body according to an example embodiment of the present invention;

FIG. 6 is a detail cut-away view of a flashlight head according to an example embodiment of the present invention;

FIG. 7 depicts a detail view of the detail circle of FIG. 6;

FIG. 8 illustrates a detail cut-away view of a flashlight head according to an example embodiment of the present invention;

FIG. 9 illustrates a detail cut-away view of a flashlight head and light source supporting structure according to an example embodiment of the present invention; and

FIG. 10 illustrates an example embodiment in which the flashlight body may be used as a power source for an accessory.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the present invention are generally described and depicted as embodied within a flashlight form factor; however, as will be apparent, embodiments of the present invention may be scalable and may be used in a number of form factors, such as head lamps, maritime lighting, search and rescue lights (e.g. floodlights, spotlights), among others. As such, the disclosure is intended to merely provide example embodiments and not to be limiting.

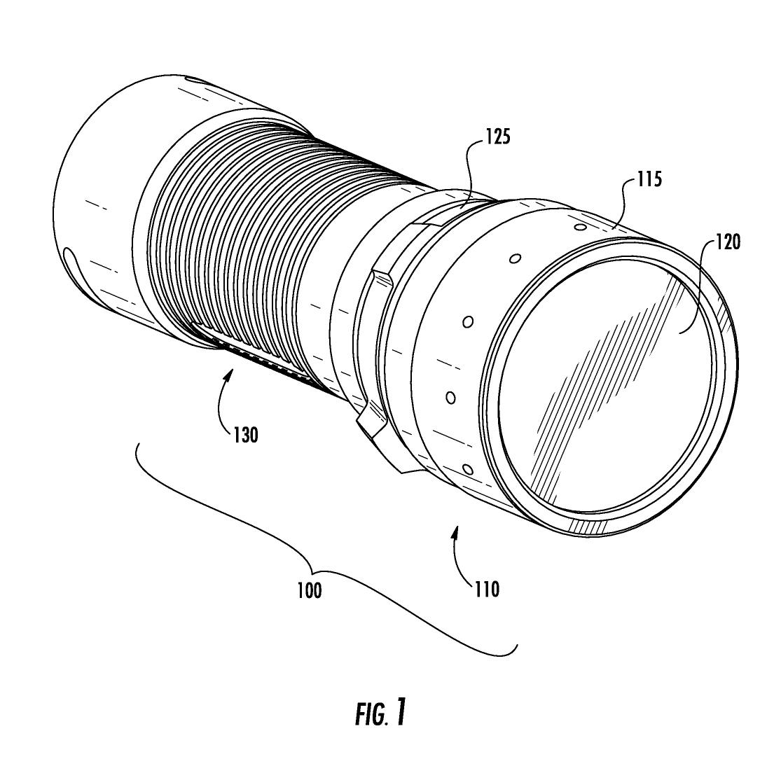

Referring now to the example of FIG. 1, embodiments of the present invention may be implemented in flashlights, such as the flashlight 100 of FIG. 1 with a flashlight head 110 including a light source housing 115, a primary lens 120, and a switch 125 that may include a rotatable collar as will be described further below. The flashlight head 110 may be attached to a flashlight body 130 which may include a power source therein for powering the light source.

Embodiments of the flashlight disclosed herein may include features that enable operation of the flashlight in an underwater environment by sealing one or more cavities in which the light source and the light source driving circuit are disposed, and separately sealing a cavity in which the power source is disposed. The sealing of the power source and the light source independently of one another enables the light source to be de-coupled from the power source in an underwater environment to allow a new power source to be coupled to the light source, or another light source coupled to the power source. Optionally, the power source may be used for functions other than the flashlight described herein, such as for tools or accessories that may be used in an underwater environment, such as power tools (e.g., drills, screwdrivers, augers, saws, etc.), underwater propulsion devices, etc. Such a configuration may also enable a single flashlight head 110 to be used with multiple power sources to improve the useful life while submerged.

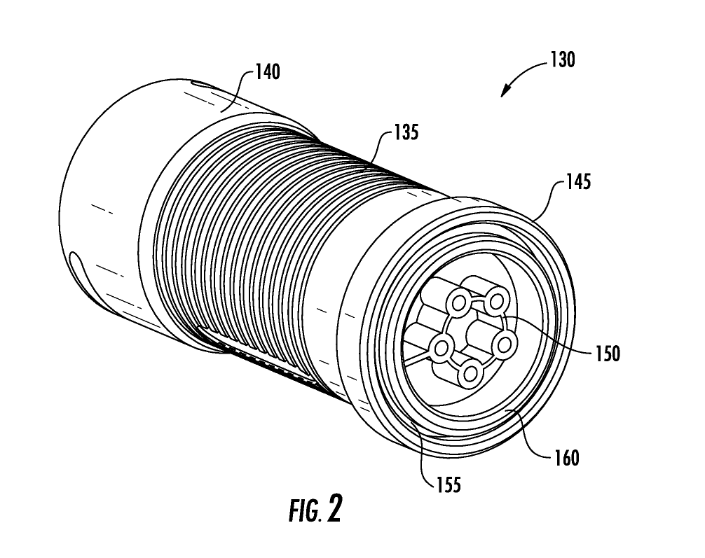

FIG. 2 illustrates an example embodiment of a power source that may be implemented according to various embodiments of the present invention. The illustrated power source is embodied by the flashlight body 130 and includes a main body 135, an end cap 140, a collar 145 encircling the main body, and electrical connector 150. The main body 135, the end cap 140, and the electrical connector 150 cooperate to form a hermetically sealed cavity for the power source contained therein. The power source may be any conventional power source, such as a battery (e.g., lead-acid, nickel-metal hydride, lithium ion, etc.) or a capacitor (e.g., a super capacitor). The power source of example embodiments may be rechargeable such that the cavity containing the power source does not require access for a user to change the power source. Further, a vent (not shown) may be present, such as in the end cap 140 of the flashlight body 130, in order to vent any gases that may be generated by the power source. Such a vent may be normally closed and biased in the closed position such that the vent will only allow gases to escape the cavity when sufficient pressure has built within the flashlight body 130 to drive the vent to an open position. In such a case, the internal pressure within the cavity would be greater than an environment in which the flashlight body 130 is disposed, resulting only in gas being expelled from the cavity without allowing environmental gas or fluid to enter the cavity of the power source through the vent.

The illustrated embodiment of FIG. 2 further includes a seal 155 disposed about a neck 160 of the flashlight body 130. As will be described further below, the seal 155 may enable a gas- or fluid-tight seal to be established between the flashlight body 130 and a light source or other power-receiving accessory to which the flashlight body 130 is coupled. The seal 155 may be, for example, an O-ring received within a channel about the neck 160. The collar 145 may be rotatable relative to the main body 135 and may include a threaded internal surface.

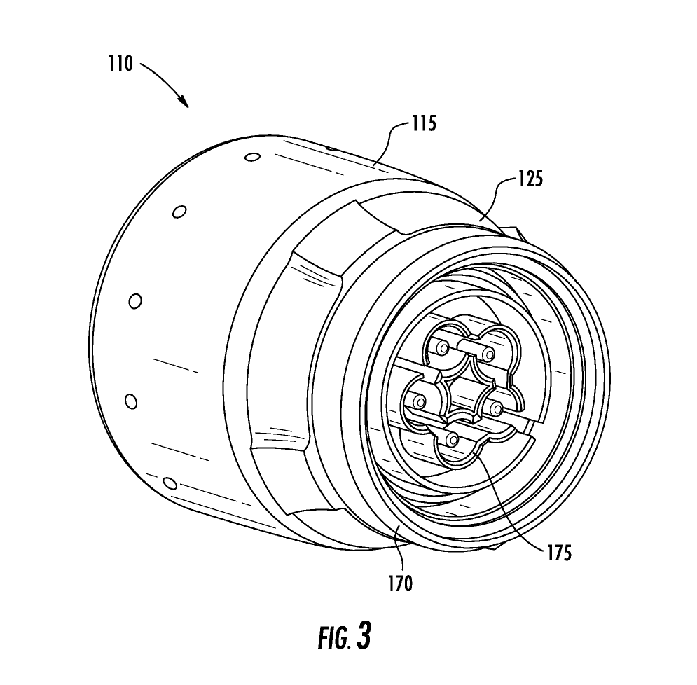

FIG. 3 illustrates a flashlight head 110 including light source housing 115 as de-coupled from the flashlight body 130. As shown, the flashlight head 110 includes a switch embodied by a rotatable collar 125, an electrical connector 175 configured to engage the electrical connector 150 of the flashlight body 130, and the flashlight head 110 may include a threaded portion 170. The threaded portion may be configured to engage the collar 145 of the flashlight body 130 as described further below. The threaded portion may be part of a light source supporting structure received within the light source housing 115.

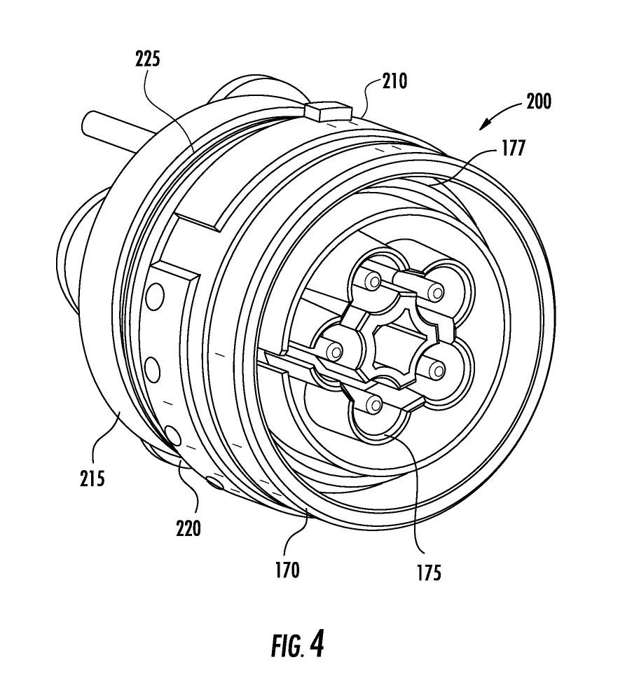

FIG. 4 illustrates an example embodiment of a light source supporting structure 200 that may be received within the light source housing 115 as shown in FIG. 3. The light source supporting structure 200 may include a housing 210 having a first longitudinal end at which the threaded portion 170 may be disposed, and a second longitudinal end 215 for supporting the light source(s). The light source supporting structure 200 may include a cavity extending from the first longitudinal end. This cavity may receive therein a light source driving circuit, which is not visible in the illustrated embodiment of FIG. 4. The light source driving circuit may be within the cavity, behind the electrical connector 175 which may include a flange 177 configured to seal the cavity and the light source driving circuit therein. The flange 177, as illustrated, may be recessed within the cavity from the opening to keep the electrical connector 175 from protruding substantially and being vulnerable to damage when the flashlight head 110 is removed from the flashlight body 130.

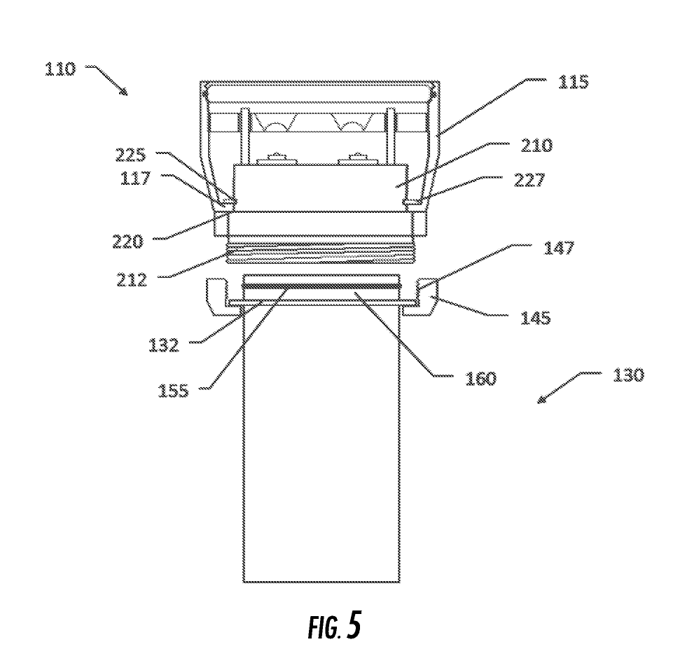

The light source supporting structure 200 may be received within the light source housing 115 and coupled thereto by a flange 220 abutting a face of the light source housing 115 and a snap-ring received about channel 225. FIG. 5 is a cut-away view of a flashlight according to an example embodiment of the present invention. As shown, the housing 210 of the light source supporting structure 200 is received within the light source housing 115, with flange 220 abutting an edge 117 of the light source housing with snap ring 227 received within channel 225 to secure the housing 210 of the light source supporting structure within the light source housing 115.

The depicted embodiment of FIG. 5 includes the flashlight body 130 and flashlight head 110 separated from one another. The flashlight body includes collar 145 with a threaded inner surface 147 configured to engage the threaded external surface 212 of the first end of the light source supporting structure. When the threaded collar 145 engages the threaded external surface 212 of the light source supporting structure, in response to tightening, the collar, acting on flange 132, draws the flashlight body 130 into engagement with the flashlight head 110. The neck 160 of the flashlight body 130 is received within the cavity of the light source supporting structure 200, and the electrical connectors 150 and 175 are brought into engagement with one another. Seal 155 engages the inner surface of the cavity of the light source supporting structure and serves to seal the electrical connection from external elements such as dirt and water.

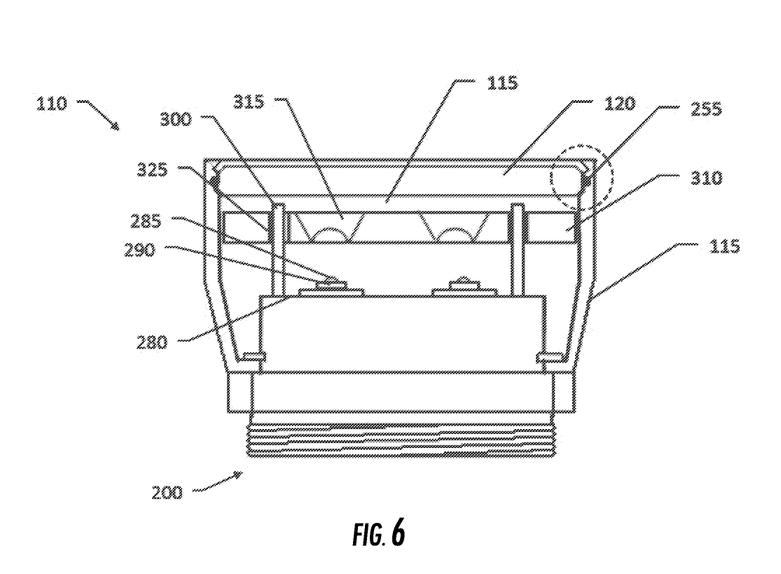

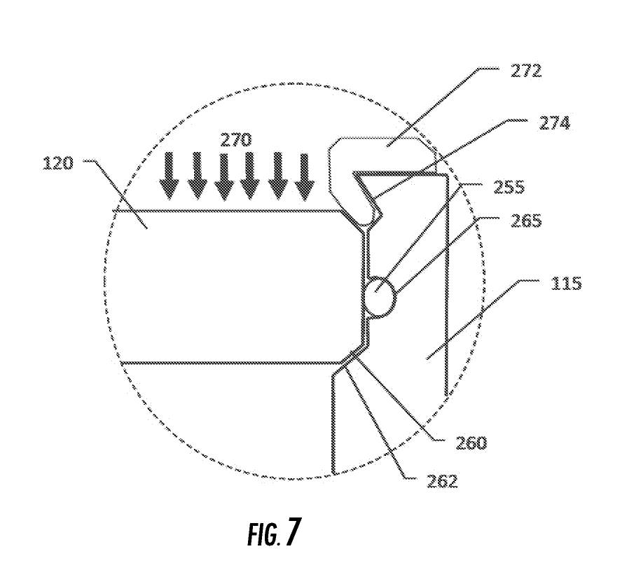

FIG. 6 illustrates a detail cut-away view of the flashlight head 110. According to the depicted embodiment, the flashlight head 110 includes the light source housing 115 and the light source supporting structure 200. The light source housing 115 receives therein a primary lens 120 which is held tightly in place with an o-ring annular seal 255 disposed about the perimeter of the primary lens and received within an annular channel around the inner surface of the light source housing 115. The primary lens may be of a substantial thickness (e.g., about 0.100 inches to 0.250 inches) to resist increased atmospheric pressure, such as experienced when the flashlight is submerged in water. A detail view of the portion of the primary lens 120 and the light source housing 115 is depicted in FIG. 7, which details the bevel 260 of the primary lens and the annular seal 255 within annular channel 265. The bevel 260 cooperates with the seal 255 to form a hermetic seal. The bevel 260 of the lens is supported on a complementary beveled lens support 262 which acts as a shelf on which the lens 120 is supported. FIG. 7 illustrates a force exerted at arrows 270 as would be experienced in response to the flashlight being submerged in water. As the pressure builds with depth, the force at 270 increases. As the force at 270 increases, the primary lens is pushed into engagement with the beveled lens support 262. The support of the lens 120 around the perimeter of the lens provides a robust mechanism to support the lens without concentrating stress on any particular point of the lens such that the lens may be resilient to greater pressures (e.g., force 270) than a conventional flashlight lens. Further, pressure on the lens at 270 maintains the lens against the lens support 262 and the perimeter of the lens in contact with the annular seal 255 to maintain a water-proof seal between the lens and the light source housing 115.

Also illustrated in FIG. 7 is a lens retaining seal 272 configured to be seated around the front of the light source housing with a portion of the lens retaining seal 272 engaging a channel 274 defined between the lens 120 and the light source housing 115. The lens retaining seal may be made, for example, of a flexible rubber or the like, and may function to retain the lens 120 within the light source housing 115 against the lens support 262 when the flashlight is in ambient conditions and there are no external forces acting upon the lens at 270. The lens retaining seal 272 may further retain the lens 120 within the light source housing 115 when the flashlight experiences a low-pressure environment, such as at high altitude, where pressure may be applied to the lens opposite the direction of arrows 270. The seal provided by the lens retaining seal 272 need not be as robust to pressure as the lens support 262 as the pressure within the light source housing 115 is unlikely to be more than one atmosphere of pressure greater than the ambient pressure of the environment surround the flashlight.

Referring back to FIG. 6, the light source supporting structure 200 includes a surface 280 upon which the light source 285 is received. The light source may include, for example, a light-emitting diode (LED) and may be retained to the light source supporting structure 200 by bracket 290. The bracket may hold the light source securely against the light source supporting structure 200 in order to more efficiently conduct heat away from the light source to the light source supporting structure, for dissipation through the light source housing 115 and the flashlight body 130. In order to better conduct heat, the light source housing 115 may be coupled to the light source supporting structure with a substantial interfacing surface area of materials of high conductivity. For example the light source supporting structure 115 may be made of a high-conductivity material, such as aluminum, and may conduct heat away from the light source 285, and into the light source housing 115, which may also be made of a high-conductivity material, such as aluminum. The flashlight body may also be made of a high-conductivity material and heat may be transferred between the light source supporting structure 200 to the flashlight body 130 through the threaded interface of the collar 145 and the external threads 212 of the light source supporting structure. In this manner, it may be desirable that the light source supporting structure be fabricated from a single, unitary piece of material, such as die-cast and machined aluminum or a solid billet of aluminum in order to maximize heat dissipation away from the light source 285. While aluminum is described as a potential material for the light source supporting structure 200, a light source housing 115, and a flashlight body 130, other materials that are good conductors that can provide the necessary structure, rigidity, and durability, may also be used. Materials may include magnesium, aluminum alloys, stainless steel, etc.

The light source supporting structure 200 may further include one or more pins 300 extending from the surface 280 toward the primary lens 120. A lens carrier 310 may include one or more lenses 315 which may include a convex shaped lens for focusing light emitted from the light source 285. While the primary lens 120 may be substantially for protecting a cavity 320 defined within the light source housing 115, between the primary lens and the light source supporting structure 200, the lens carrier 310 may carry one or more lenses whose primary function is focusing the light emitted from the light source 285. As shown, the lens carrier includes passages 325 configured to receive therein the pins 300. The lens carrier 310 may be adjustable along the pins 300 such that the distance between the light source 280 and the lens 315 of the lens carrier 310 is adjustable. Adjustment between the lens 315 and the light source 280 may allow the light emitted from the light source 285 to be focused at different distances from the flashlight.

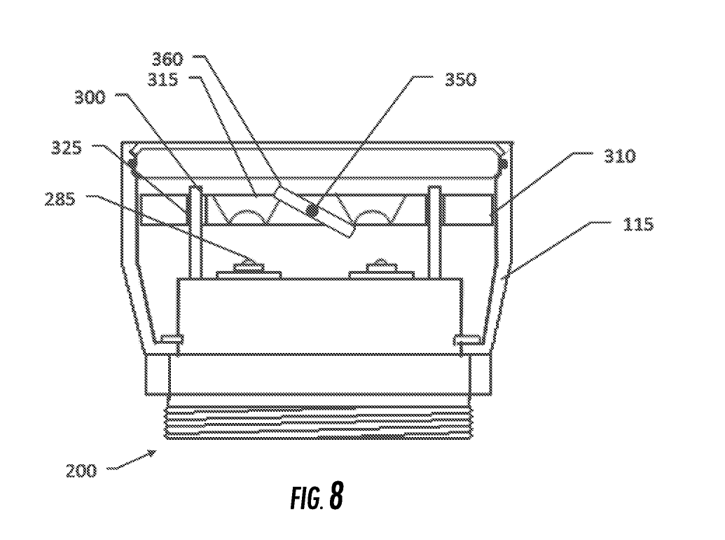

FIG. 8 illustrates an example embodiment of how the lens carrier 310 may be adjusted along the pins 300 to vary the focal distance between the lens 315 and the light source 285. The lens carrier 310 may include a focusing pin 350 fixed to the lens carrier while the light source housing 115 may include a channel 360. The pins 300 hold the lens carrier 310 in a substantially fixed rotational alignment with the light source supporting structure 200. Rotation of the light source housing 115 relative to the light source supporting structure 200 rotates the lens carrier 310 relative to the light source housing 115. As the light source housing 115 is rotated relative to the lens carrier 310, the focusing pin 350 translates within channel 360. As the channel 360 is disposed at an angle, the pin translates along the channel, causing the lens carrier 310 to move toward or away from the light source 285 depending upon the direction of rotation between the light source housing 115 and the light source supporting structure 200.

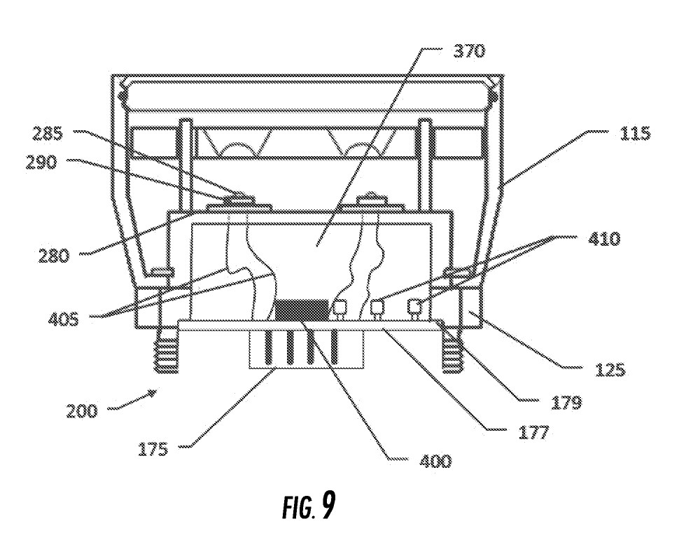

FIG. 9 illustrates a cut-away view of an example embodiment of a light source supporting structure 200. The cut-away view depicts the electrical connector 175 and flange 177. The flange 177 may be adhered to a step 179 extending around the interior surface of the cavity 370 within the light source supporting structure 200. The flange 177 may be adhered to the step 179 in such a way as to preclude water or gas from entering the cavity 370, such as through an adhesive around the perimeter of the flange 177, or a seal such as an O-ring disposed between the flange 177 and the step 179. In such an embodiment, pressure exerted on the flange 177 would serve to increase the quality of the seal between the flange 177 and the step 179. Within the cavity is the light source driving circuit 400 which may, at least partially, be embodied as a printed circuit board mounted to the side of the flange 177 facing the cavity 370. The light source driving circuit may be in electrical communication with the electrical connector 175 to receive power for driving the light source. The light source driving circuit 400 is also in electrical communication with the light sources 285 through electrical connectors 405 which may be wires that pass through orifices in the light source supporting structure 200 to reach the light sources 285. This type of connection may enable a substantial portion of the light source to remain in contact with the light source supporting structure in order to dissipate heat more efficiently.

The light source driving circuit of example embodiments may also be configured to enable multi-functionality of the light source(s). For example, the light source may be operable in various levels of brightness and may be configured to pulse or strobe. The light source driving circuit 400 may provide this functionality. However, the light source driving circuit may require user interaction in order to change between these modes.

Also included in the illustrated embodiment of the light source driving circuit 400 are sensors 410. The sensors 410 may be configured to determine a position of a switch. For example, the sensors 410 may include hall-effect sensors configured to vary an output voltage based on the presence of a magnetic field. A plurality of these sensors 410 may be disposed about a portion, or all of the perimeter of the flange 177 within the cavity 370 of the light source support structure 200. The rotatable collar 125 may include therein one or more magnets, such that rotation of the collar 125 relative to the light source supporting structure 200 may cause a change in voltage from the sensors 410. The sensors may cause a change in the output function from the light source driving circuit 400. For example, rotating the collar 125 from a first position to a second position may cause the light source driving circuit to change from a first brightness of the light source 285 to a second brightness of the light source. This type of switch may enable changing of the light functionality without requiring a physical conduit between the light source driving circuit 400 and the switch, such as required with a push-button switch. To enhance the operation of the rotatable collar switch 125, the collar may be configured to provide a tactile feedback of a position or rotation of the collar. Detents may be provided in an external surface of the light source supporting structure while a raised element (which may be spring biased into the raised position), may be disposed on the collar 125. In response to rotation of the collar 125 about the light source supporting structure 200, the raised element may move into and out of engagement with the detents, resulting in a tactile response that can be felt by a user.

In example embodiments where a detent exists for each distinct position of the adjustable ring, each distinct position of the adjustable ring may correspond to a mode of operation of the flashlight. For example, the light source 285 may be capable of operating in a bright mode and a dim mode, and possibly incremental steps of brightness therebetween. Each of these levels of brightness may be a mode of operation, such that distinct positions of the adjustable ring may correspond to a mode of operation corresponding to a particular brightness. Alternatively or additionally, the brightness may be substantially infinitely adjustable between the brightest level and the dimmest level, with no substantial detents between the two. A further mode of operation of the flashlight may include a strobe mode in which the light source is configured to flash periodically. In some example embodiments, different light wavelengths may be available as different modes of operation. For example, the light source 285 may include a visible, white light LED, an ultraviolet (e.g., 375-nanometer wavelength) LED, and an infrared (e.g., 10 m micrometer wavelength) LED. Each distinct position of the adjustable ring may correspond to operation of one of the LEDs providing different wavelength options.

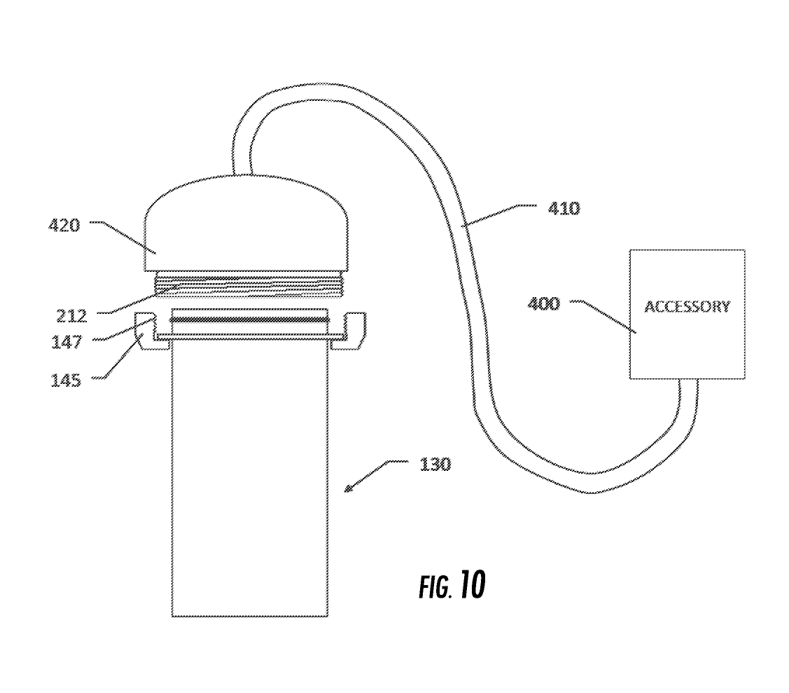

While the illustrated embodiments depict a single flashlight body 130 and single flashlight head 110, the power source of the flashlight body 130 may be interchangeable with various other flashlight heads and powered accessories. The accessories used with the power source may be configured with a power control circuit configured to regulate the power flowing to the accessory from the power source of the flashlight body 130. The power control circuit of each accessory may regulate the drawn current according to the power source. Therefore, the power source may be communication between the battery gage, which is included in the power source unit, and the lamp head or accessory. Via this communication the lamp head can show exact charge level and adjust brightness to achieve optimal runtime performance. The communication is realized by a serial communication link. These include I2C, CAN, UART and others. FIG. 10 illustrates an example embodiment in which the flashlight body may be used as a power source for an accessory 400, such as a small light source that is attached to the flashlight body through an extension cord 410 and connector 420. The extension cord 410 may enable the small light source to be worn on a user's person, for example as a headlamp or wrist-worn flashlight, while the bulk and weight of the power source is located remotely, such as on a user's belt. Further, the flashlight body may be used as a power source for a variety of other types of accessories, such as power tools, computers, entertainment devices, etc. Each of these accessories may have different power requirements, such as different voltages and/or different current requirements. In each case, the accessory 400 or the extension cable 410 used for the accessory (including the connector 420) may identify to the power source what the power requirements are, and the power source may be able to adjust accordingly.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A structure for supporting a light source comprising:
a housing having a first longitudinal end and a second longitudinal end,
a cavity defined within the housing extending along a portion of a longitudinal length of the housing from the first longitudinal end;
a surface extending across the second longitudinal end, wherein the surface comprises a light source receiving area;
an opening defined from the light source receiving area, through the surface, and opening to the cavity; and
a light source driving circuit received within the cavity and comprising at least one electrical connection extending from the light source driving circuit, through the opening to the light source receiving area,
wherein the housing is configured to be received within a flashlight.

2. The structure for supporting a light source according to claim 1, wherein the light source driving circuit comprises a power source control circuit, wherein the power source control circuit recognizes a voltage and current received from a power source and adapts the voltage and current according to an appropriate voltage and current for the light source.

3. The structure for supporting a light source according to claim 1, wherein the light source driving circuit comprises an electrical connector extending from the cavity of the cylindrical housing from the first longitudinal end of the cylindrical housing.

4. The structure for supporting a light source according to claim 1, further comprising a selector ring disposed about an exterior of the cylindrical housing, wherein the selector ring comprises a magnet, and wherein the light source driving circuit comprises at least one sensor for detecting a position of the magnet of the selector ring.

5. The structure for supporting a light source according to claim 1, further comprising a light source bracket attached to the surface and configured to secure a light source to the light source receiving area.

6. A flashlight comprising:
a flashlight head comprising:
a light source housing;
a light source supporting structure disposed at least partially within the light source housing, wherein at least one of the light source housing and the light source supporting structure comprises a threaded end; and
a lens carrier received within the light source housing, wherein the lens carrier is translatable within the light source housing between a first distance relative to the light source supporting structure and a second distance relative to the light source supporting structure;
wherein the threaded end of the flashlight head is configured to engage a flashlight body.

7. The flashlight of claim 6, wherein the lens carrier is translatable relative to the light source supporting structure in response to the light source housing being rotated relative to the light source supporting structure.

8. The flashlight of claim 6, wherein the flashlight body comprises a collar comprising a threaded inner surface, and wherein the threaded inner surface of the collar is configured to engage the threaded end of the light source housing or the light source supporting structure.

9. The flashlight of claim 8, wherein the light source supporting structure comprises an electrical connector, and wherein the flashlight body comprises an electrical connector, wherein in response to the threaded collar of the flashlight body engaging the threaded end of the light source housing or the light source supporting structure, the electrical connector of the flashlight body engages the electrical connector of the light source supporting structure.

10. The flashlight of claim 9, wherein the electrical connector of the light source supporting structure and the electrical connector of the flashlight body comprise a keyed interface, wherein the electrical connectors are engagable with one another in a single rotational position there between based on the keyed interface.

11. The flashlight of claim 10, wherein the threaded collar is rotatable relative to the flashlight body, and wherein the flashlight body is secured to the flashlight head in response to the threaded collar engaging the threads of the light source housing or the light source supporting structure and being rotated relative to the flashlight head and the flashlight body, while the flashlight body and flashlight head remain in rotational alignment.

12. The flashlight of claim 6, wherein the light source supporting structure comprises at least one pin extending therefrom, wherein the lens carrier defines at least one aperture configured to receive therein the pin extending from the light source supporting structure, wherein the lens carrier is translatable along at least a portion of the length of the pin.

13. The flashlight of claim 6, further comprising a primary lens received at a first end of the flashlight head, opposite the threaded end, and wherein the lens carrier is disposed within a closed cavity defined by the light source housing, the light source supporting structure, and the primary lens.

14. The flashlight of claim 13, further comprising a first seal disposed about the perimeter of the primary lens, and a second seal disposed between the light source supporting structure and the light source housing, wherein the first seal and the second seal cooperate to render the cavity impervious to water when the flashlight is submerged at a depth of at least twelve inches.

15. The flashlight of claim 14, wherein the flashlight body defines a cavity therein comprising at least one power source, wherein the cavity of the flashlight body is impervious to water at a depth of at least twelve inches.

16. The flashlight of claim 14, wherein the cavity is impervious to water when the flashlight is submerged in water at a depth of at least one hundred feet.

17. A light emitting device comprising:
a light source housing;
a light source supporting structure disposed at a first end of the light source housing;
a primary lens disposed at a second, opposite end of the light source housing; and
a lens carrier disposed between the light source supporting structure and the primary lens, wherein the lens carrier is adjustable along a length defined between the light source supporting structure and the primary lens.

18. The light emitting device of claim 17, wherein the light source supporting structure comprises a plurality of light sources, and wherein the lens carrier comprises a plurality of lenses, each lens corresponding to a respective light source.

19. The light emitting device of claim 17, wherein the light source supporting structure comprises at least one pin extending therefrom, wherein the lens carrier comprises at least one passage corresponding to the at least one pin, and wherein the lens carrier is configured to translate along a portion of a length of the at least one pin.

20. The light emitting device of claim 19, wherein one of the light source housing and the lens carrier comprises at least one focusing pin, and wherein the other of the light source housing and the lens carrier comprises at least one channel corresponding to the at least one focusing pin, wherein in response to the light source housing being rotated relative to the light source supporting structure, the at least one focusing pin translates along the at least one channel to move the lens carrier along the portion of the length of the at least one pin.
